(19) United States
(12) Patent Application Publication
(10) Pub. No.: US 2023/0041003 A1
(43) Pub. Date: Feb. 9, 2023

(54) MICROSCOPE AUXILIARY APPARATUS

(71) Applicant: CANON KABUSHIKI KAISHA, Tokyo (JP)

(72) Inventor: Hitoshi Nishitani, Tokyo (JP)

(21) Appl. No.: 17/969,082

(22) Filed: Oct. 19, 2022

Related U.S. Application Data
(63) Continuation of application No. PCT/JP2021/009524, filed on Mar. 10, 2021.

(30) Foreign Application Priority Data
Apr. 30, 2020 (JP) 2020-080813

(51) Int. Cl. G02B 21/26; G02B 21/36

(52) U.S. Cl. CPC G02B 21/26; G02B 21/362

(57) ABSTRACT

A microscope auxiliary apparatus attachable to a microscope includes an object movable portion for moving an object in an optical axis direction of the microscope, first and second operating unit movable portions for respectively moving, in the optical axis direction, first and second operating units for operating the object, a movement instructing unit for instructing the object movable portion or the first or second operating unit movable portions to move, and a switching unit for switching a mode to first and second modes. The first mode moves one of the movable portions in the optical axis direction according to an instruction from the movement instructing unit. The second mode links movements of at least two of the movable portions and moves the at least two in the optical axis direction according to the instruction from the movement instructing unit.

### CROSS-REFERENCE TO RELATED APPLICATIONS

This application is a Continuation of International Patent Application No. PCT/JP2021/009524, filed on Mar. 10, 2021, which claims the benefit of Japanese Patent Application No. 2020-080813, filed on Apr. 30, 2020, which is hereby incorporated by reference herein in its entirety.

### BACKGROUND OF THE INVENTION

### Field of the Invention

An aspect of embodiments of the present disclosure relates to a microscope auxiliary apparatus used while being attached to a microscope in order that an object such as a microscopic cell and a semiconductor element are observed or that a mechanical manipulation such as sorting, cutting, and moving an object is performed.

### Description of the Related Art

When focus of a microscope is to be adjusted, manual focusing is usually performed by manually rotating a knob provided on the microscope and moving an objective lens in an optical axis direction while a position of an object is fixed in the optical axis direction. On the other hand, there is a method of using an object movable portion, generally called a “hollow stage”, on which an object can be placed and that can be electrically moved in the optical axis direction while an observation light path or illumination light path of the microscope is not blocked. This method makes it possible to electrically move an object in an optical axis direction without moving an objective lens in the optical axis direction, and thus enables autofocusing.

When autofocusing is to be performed, an image pickup unit is attached to the microscope and an image is acquired. Conventional techniques commonly used in digital cameras can be applied to autofocusing. For example, there are a contrast method with which autofocusing is performed by evaluating a contrast of an acquired image, an image pickup plane phase difference method with which autofocusing is performed by comparing two images of which an image pickup unit can detect a phase difference by pupil division in a predetermined direction, and the like.

In order that an operating unit such as a pipette, a probe, and tweezers for mechanically manipulating an object is moved in a plurality of axial directions, an operating unit movable portion, generally called a “micromanipulator”, is used while being attached to the microscope. The operating unit movable portion includes a combination of stages capable of moving an operating unit in a plurality of axial directions. Movements in the plurality of axial directions include at least a movement in an optical axis direction for focusing, and usually include movements in three axial directions of XYZ including movements in a planar direction orthogonal to the optical axis direction.

Japanese Patent Application Laid-Open No. 2008-233545 discloses a method of controlling a micromanipulator based on image information acquired by an image pickup unit. Yasuhisa Araki, “Technical Textbook for Assisted Reproductive Technology”, Ishiyaku Publishers, Inc. (hereinafter, referred to as “Araki”) discloses cell manipulation using micromanipulators.

However, in conventional configurations, an electric operation that moves the object placed on the object movable portion in the optical axis direction and an electric operation that moves the operating unit attached to the operating unit movable portion in the optical axis direction are not linked to each other. Therefore, in a case where the focus is to be readjusted after the object and the operating unit are focused on, the object movable portion and the operating unit movable portion are moved individually, which takes time to readjust the focus.

### SUMMARY OF THE INVENTION

The present disclosure provides a microscope auxiliary apparatus that can shorten an operation time by linking movements, in the optical axis direction, of at least two movable portions including an object movable portion or an operating unit movable portion.

A microscope auxiliary apparatus according to one aspect of the embodiments of the present disclosure is attachable to a microscope. The microscope auxiliary apparatus includes an object movable portion, a first operating unit, a second operating unit movable portion, a movement instructing unit, and a switching unit. The object movable portion is configured to move an object in an optical axis direction of the microscope. The first operating unit movable portion is configured to move, in the optical axis direction, a first operating unit for operating the object. The second operating unit movable portion is configured to move, in the optical axis direction, a second operating unit for operating the object. The movement instructing unit is configured to instruct the object movable portion, the first operating unit movable portion, or the second operating unit movable portion to move in the optical axis direction. The switching unit is configured to switch a mode to a first mode and a second mode. The first mode is a mode that moves one of the object movable portion, the first operating unit movable portion, and the second operating unit movable portion in the optical axis direction according to an instruction from the movement instructing unit. The second mode is a mode that links movements of at least two of the object movable portion, the first operating unit movable portion, and the second operating unit movable portion and moves the at least two in the optical axis direction according to the instruction from the movement instructing unit.

A microscope auxiliary apparatus according to one aspect of the embodiments of the present disclosure is attachable to a microscope. The microscope auxiliary apparatus includes an operating unit and an image pickup unit. The operating unit movable portion is configured to move, in an optical axis direction of the microscope, an operating unit for operating an object. The image pickup unit is configured to acquire an observation image of the microscope. Based on the observation image, the operating unit movable portion moves in the optical axis direction by a same distance as a moving distance of an objective lens of the microscope in the optical axis direction while a movement of the operating unit movable portion is linked to a movement of the objective lens.

A microscope auxiliary apparatus according to one aspect of the embodiments of the present disclosure is attachable to a microscope. The microscope auxiliary apparatus includes an operating unit movable portion, an image pickup unit, an image pickup unit rotating unit, and an image rotating unit. The operating unit movable portion is configured to move, at least in an optical axis direction of the microscope, an operating unit for operating an object. The image pickup unit is configured to acquire two images by pupil division in a predetermined direction so that a phase difference is detected. The image pickup unit rotating unit is configured to rotate the image pickup unit relatively to the microscope. The image rotating unit is configured to generate a rotated image by rotating, by a predetermined angle, an image acquired by the image pickup unit.

Further features of the present invention will become apparent from the following description of exemplary embodiments with reference to the attached drawings.

### BRIEF DESCRIPTION OF THE DRAWINGS

FIGS. 1A and 1B are entire views of a microscope system according to a first embodiment.

FIGS. 2A to 2C are explanatory diagrams of a console according to the first embodiment.

FIGS. 3A and 3B are explanatory diagrams of processes according to the first embodiment.

FIG. 4 is a flowchart of processes according to the first embodiment.

FIGS. 5A to 5C are explanatory diagrams of effects of the first embodiment.

FIGS. 6A and 6B are entire views of a microscope system according to a second embodiment.

FIGS. 7A and 7B are explanatory diagrams of processes according to the second embodiment.

FIG. 8 is a flowchart of processes according to the second embodiment.

FIGS. 9A and 9B are explanatory diagrams of effects of the second embodiment.

FIGS. 10A and 10B are entire views of a microscope system according to a third embodiment.

FIG. 11 is a block diagram of feedback control in a linked mode according to the third embodiment.

FIGS. 12A to 12C are explanatory diagrams of effects of the third embodiment.

FIGS. 13A to 13C are entire views of a microscope system according to a fourth embodiment.

FIGS. 14A to 14E are explanatory diagrams of effects of the fourth embodiment.

FIGS. 15A to 15C are entire views of a microscope system according to a fifth embodiment.

FIGS. 16A to 16E are explanatory diagrams of effects of the fifth embodiment.

### DESCRIPTION OF THE EMBODIMENTS

Referring now to the drawings, a detailed description is given of embodiments according to the present disclosure.

### First Embodiment

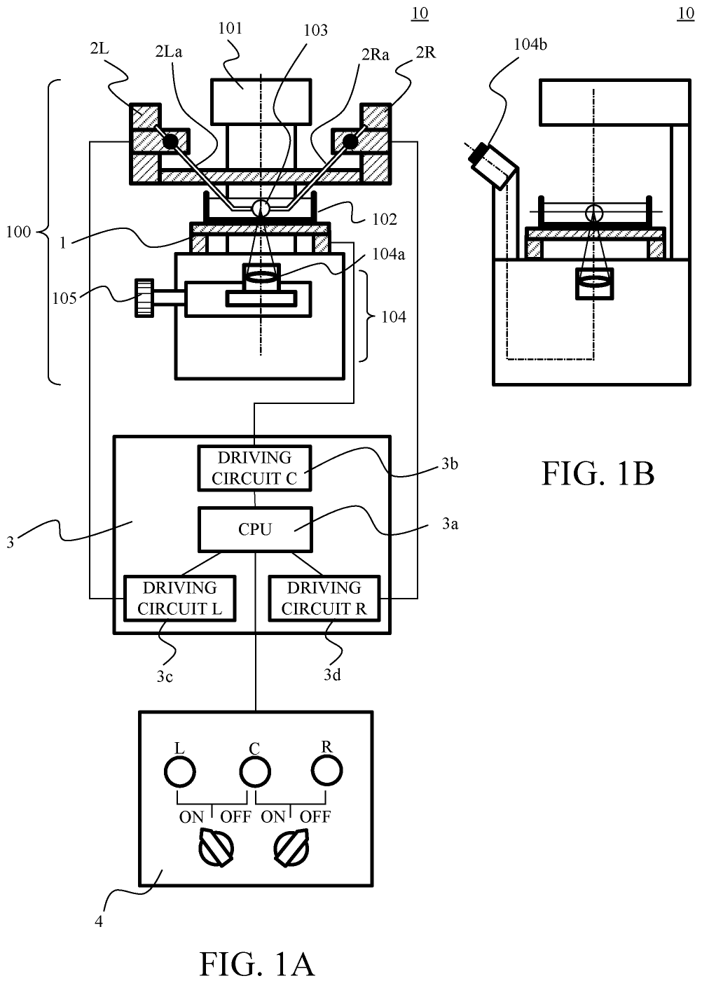

First, a description is given of a microscope system according to a first embodiment of the present disclosure. FIGS. 1A and 1B are entire views of a microscope system 10 including a microscope (inverted microscope) 100 and a microscope auxiliary apparatus and illustrate a state in which the microscope auxiliary apparatus is attached to the microscope 100. The microscope auxiliary apparatus includes an object movable portion 1, an operating unit movable portions 2L and 2R, a controller 3, and a console 4. FIG. 1A illustrates a front view of the microscope system 10, and FIG. 1B illustrates a right view of the microscope system 10. In FIGS. 1A and 1B, for clarity, some dimensions are exaggerated, some components are omitted, and some internal components are drawn with solid lines instead of dotted lines.

The microscope 100 is configured to cause an illumination optical system 101 to illuminate an object 103 placed on a transmissive observation tray 102 and to allow observation of the object 103 through an observation optical system 104. The observation optical system 104 allows an enlarged image obtained through an objective lens 104a to be observed with a naked eye at an eyepiece lens 104b via unillustrated other lenses or an unillustrated refractive optical system. Focus can be adjusted by finely moving the objective lens 104a in an optical axis direction (vertical direction in FIGS. 1A and 1B). This fine movement is performed by rotating a knob 105 provided on the microscope 100, and the rotation amount of the knob 105 is converted into a fine moving amount of the objective lens 104a via a deceleration transmission mechanism (not illustrated).

The object movable portion 1, which is a part of the microscope auxiliary apparatus, is generally called a “hollow stage”, etc., and an observation tray 102 on which an object 103 is placed on the object movable portion 1. The object movable portion 1 includes a driving mechanism that can move the object 103 in the optical axis direction of the microscope 100.

The operating unit movable portions 2L and 2R, which are part of the microscope auxiliary apparatus, are generally called “micromanipulators”, etc., and are attached to left and right sides of the microscope 100. The operating unit movable portions 2L and 2R include driving mechanisms that can move the operating unit 2La and 2Ra for manipulating (operating) the object 103 at least in the optical axis direction of the microscope 100. Normally, the operating unit movable portions 2L and 2R can move in three axial directions of XYZ including a planar direction orthogonal to the optical axis direction. The operating unit movable portions 2L and 2R may also move in directions of rotational axes of yaw, pitch, and roll. Further, a high-speed driving mechanism for coarse movement and a high-resolution driving mechanism for fine movement may be separately provided.

The controller 3, which is part of the microscope auxiliary apparatus, controls the object movable portion 1 and the operating unit movable portions 2L and 2R and includes a CPU 3a for controlling the entire system, and other peripheral circuits. The other peripheral circuits include a driving circuit C3b for driving the object movable portion 1 and driving circuits R3c and R3d for respectively driving the driving mechanisms of the operating unit movable portions 2L and 2R.

The driving circuit C3b has a function of controlling a movement of the observation tray 102, which is placed on the object movable portion 1, in the optical axis direction. By moving the observation tray 102 in the optical axis direction, the driving circuit C3b can align the object 103 placed on the observation tray 102 with a focus position of the objective lens 104a. The driving circuits R3c and R3d have functions of controlling movements of the operating unit movable portions 2L and 2R in the optical axis direction. By moving the operating units 2La and 2Ra in the optical axis direction, positions of tips of the operating units 2La and 2Ra can be aligned with the focus position of the objective lens 104a.

The console 4 for giving instructions to the controller 3 is provided with several inputting units for inputting necessary instructions to the object movable portion 1 and the operating unit movable portions 2L and 2R.

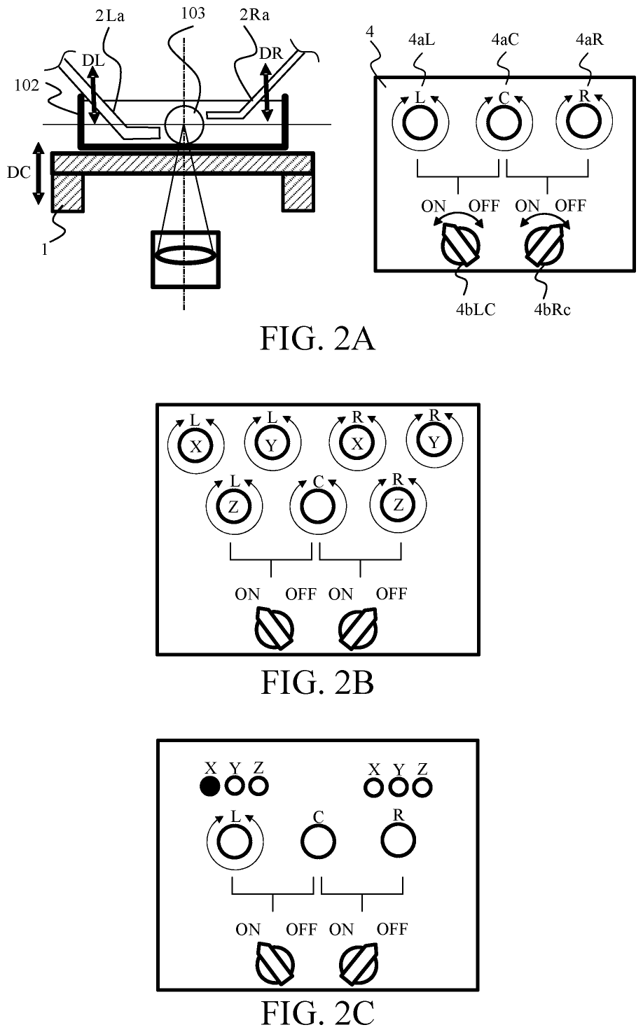

With reference to FIGS. 2A to 2C, a description is given of functions of the console 4. FIG. 2A is an explanatory diagram of functions of the console 4. Dials 4aL, 4aC, and 4aR are inputting units for adjusting the positions of the object movable portion 1 and the operating unit movable portions 2L and 2R in the optical axis direction. The dial 4aL is for the left operating unit movable portion 2L, the dial 4aC is for the object movable portion 1, and the dial 4aR is for the right operating unit movable portion 2R. According to rotation amounts of the dials 4aL, 4aC, and 4aR, the respective positions of the movable portions in the optical axis direction can be moved in directions of arrows DL, DC, and DR. Thus, the dials 4aL, 4aC, and 4aR function as a movement instructing unit that instructs the object movable portion 1 or the operating unit movable portion 2L or 2R to move in the optical axis direction of the microscope 100. The dials 4aL, 4aC, and 4aR are an example of a manual movement instructing unit for inputting moving amounts and moving directions according to the rotation amount. In this embodiment, as a manual movement instructing unit via which a moving amount and a moving direction are input, a sliding-type inputting unit, a lever-tilting-type inputting unit, a touch panel, and the like can also be applied.

Inputting units similar to the dials 4aL, 4aC, and 4aR are to be also provided for movements of the operating unit movable portions 2L and 2R in directions other than the optical axis, such as XY directions. FIG. 2B illustrates an example in which dials LX, LY, RX and RY are added for movements of the operating unit movable portions 2L and 2R in the XY directions. Alternatively, as illustrated in FIG. 2C, two sets of button switches X, Y, and Z may be provided, and the button switches X, Y, and Z may be used to switch directions in which the operating unit movable portions 2L and 2R are moved by operations on the dials 4aL and 4aR. For example, when a button switch X as a changeover switch is pressed, operating the dial 4aL moves the operating unit movable portion 2L in the X direction. In this embodiment, an input unit such as a stick-shaped lever may be used instead of the dial. Further, a function may be provided with which magnifications of moving amounts of the object movable portion 1 and the operating unit movable portions 2L and 2R with respect to the respective rotation amounts of the dials can be freely changed. A description is omitted of the inputting units for a movement in a direction other than the optical axis direction and the unit for changing the magnifications.

In FIG. 2A, motion modes can be switched by operating left and right changeover switches 4bLC and 4bRC. In this embodiment, the changeover switches 4bLC and 4bRC are a changeover switch capable of reciprocating in two directions including “ON” for enabling a “linked mode” described below and “OFF” for disabling the “linked mode”.

By disabling the linked mode, the mode is switched to a non-linked mode in which the object movable portion 1 and the operating unit movable portions 2L and 2R are independently moved according to the instructions to the dials 4aL, 4aC, and 4aR, respectively. By enabling the linked mode, the mode is switched to the linked mode in which at least two movable portions of the object movable portion 1 and the operating unit movable portions 2L and 2R are simultaneously moved by the same moving amount according to the instructions to the dials 4aL, 4aC, and 4aR. Thus, the changeover switches 4bLC and 4bRC function as a switching unit that switches the mode to the non-linked mode (first mode) and the linked mode (second mode).

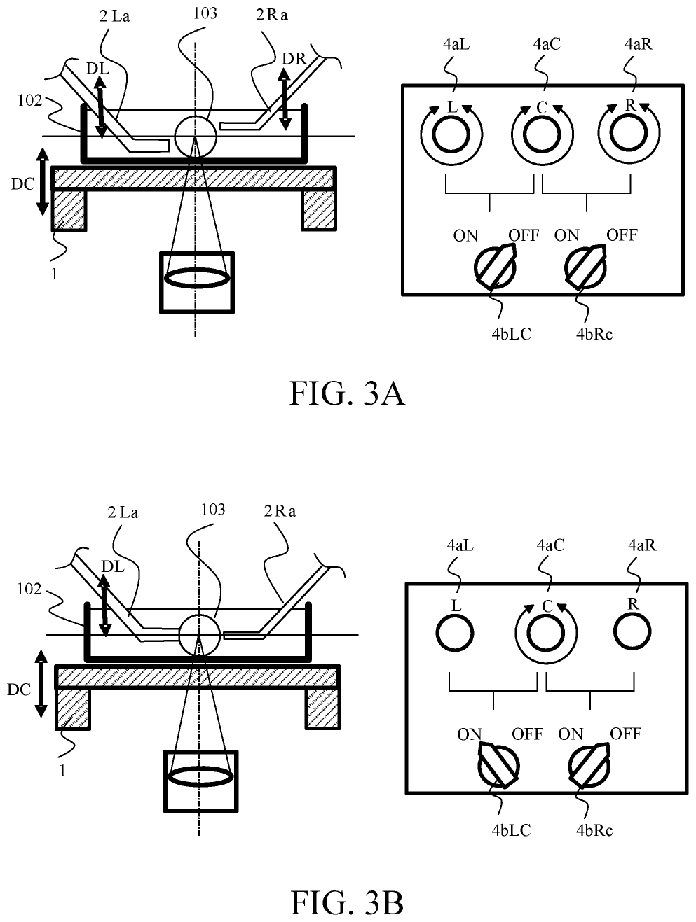

FIG. 3A is an explanatory diagram of processes in this embodiment. First, with reference to FIG. 3A, a description is given of the non-linked mode during manual focusing. First, the changeover switches 4bLC and 4bRC are all switched to a linked mode OFF side. When the dial 4aC is operated, only the object movable portion 1 moves in the optical axis direction (DC direction in FIG. 3A). Therefore, while an image is viewed, it is possible to focus on a desired portion of the object 103 placed on the observation tray 102. At this time, the focus on the operating units 2La and 2Ra attached to the operating unit movable portions 2L and 2R remains unchanged.

Similarly, when the dials 4aL and 4aR are operated, only the operating units 2La and 2Ra respectively attached to the left and right operating unit movable portions 2L and 2R move in the optical axis direction (DL and DR directions in FIG. 3A). Therefore, while an image is viewed, it is possible to focus on the operating units 2La and 2Ra. At this time, the focus on the object 103 remains unchanged.

Next, with reference to FIG. 3B, a description is given of the linked mode during manual focusing. A description is given of an example in which movements of the left operating unit movable portion 2L and the object movable portion 1 are linked. First, the changeover switch 4bLC is switched to a linked mode ON side, and the changeover switch 4bRC is switched to the linked mode OFF side. As in a state where the linked mode is disabled, when the dial 4aC is operated, the object movable portion 1 moves in the optical axis direction, and thereby, while an image is viewed, it is possible to focus on a desired portion of the object 103 placed on the observation tray 102. Here, in a state where the linked mode is enabled, the left operating unit movable portion 2L for which the linked mode is selected also moves in the optical axis direction by the same moving amount and at the same speed as the moving amount and the speed of the object movable portion 1. As a result, the focus on the operating unit 2La attached to the left operating unit movable portion 2L also changes similarly to the focus on the object 103. On the other hand, since the operating unit 2Ra attached to the right operating unit movable portion 2R, for which the linked mode is not selected, does not move in the optical axis direction, the focus thereon does not change.

Similarly, by switching the changeover switch 4bLC to the linked mode OFF side and the changeover switch 4bRC to the linked mode ON side, movements of the right operating unit movable portion 2R and object movable portion 1 can be linked. By switching both the changeover switches 4bLC and 4bRC to the linked mode ON side, movements of the three movable portions of the operating unit movable portions 2L and 2R and the object movable portion 1 can be linked.

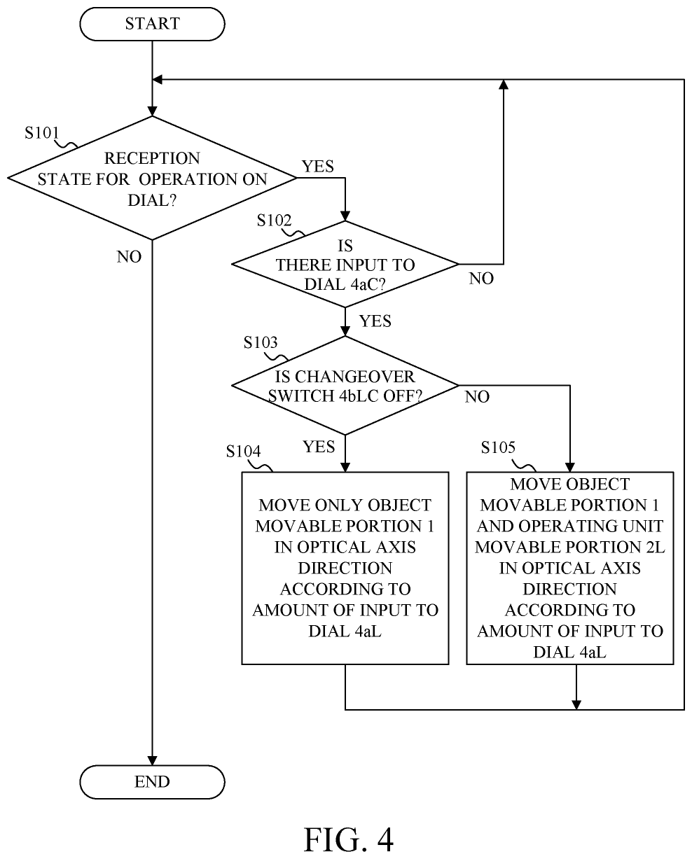

FIG. 4 is a flow chart illustrating the flow of a response to the dial 4aC as an example of the processes illustrated in FIGS. 3A and 3B. First, in step S101, the controller 3 determines whether or not it is in a reception state for receiving an operation on the dial 4aC. If it is in the reception state, the process proceeds to step S102. On the other hand, if it is not in the reception state, this flow ends.

In step S102, the controller 3 determines whether or not there is an input to the dial 4aC. If there is an input, the process proceeds to step S103. On the other hand, if there is no input, the process returns to step S101.

In step S103, the controller 3 determines whether or not the changeover switch 4bLC is OFF. If the changeover switch 4bLC is OFF, the process proceeds to step S104. On the other hand, if the changeover switch 4bLC is ON, the process proceeds to step S105.

In step S104, since the changeover switch 4bLC is OFF, the microscope auxiliary apparatus acts in the non-linked mode. At this time, the controller 3 moves only the object movable portion 1 in the optical axis direction according to the amount of input to the dial 4aL, and the process returns to step S101.

In step S105, since the changeover switch 4bLC is ON, the microscope auxiliary apparatus acts in the linked mode. At this time, the controller 3 moves the object movable portion 1 and the operating unit movable portion 2L in the optical axis direction according to the amount of input to the dial 4aL, and the process returns to step S101.

A description is given of effects of the linked mode in cell manipulation as an example. In cell manipulation, a holding pipette HP is attached to the left operating unit movable portion 2L, and an injection pipette IP is attached to the right operating unit movable portion 2R. The holding pipette HP sucks and holds an egg or a fertilized egg, which is the object 103. The injection pipette IP injects sperm into the egg or a special cell, etc. into the fertilized egg. A detailed description thereof is given in Araki.

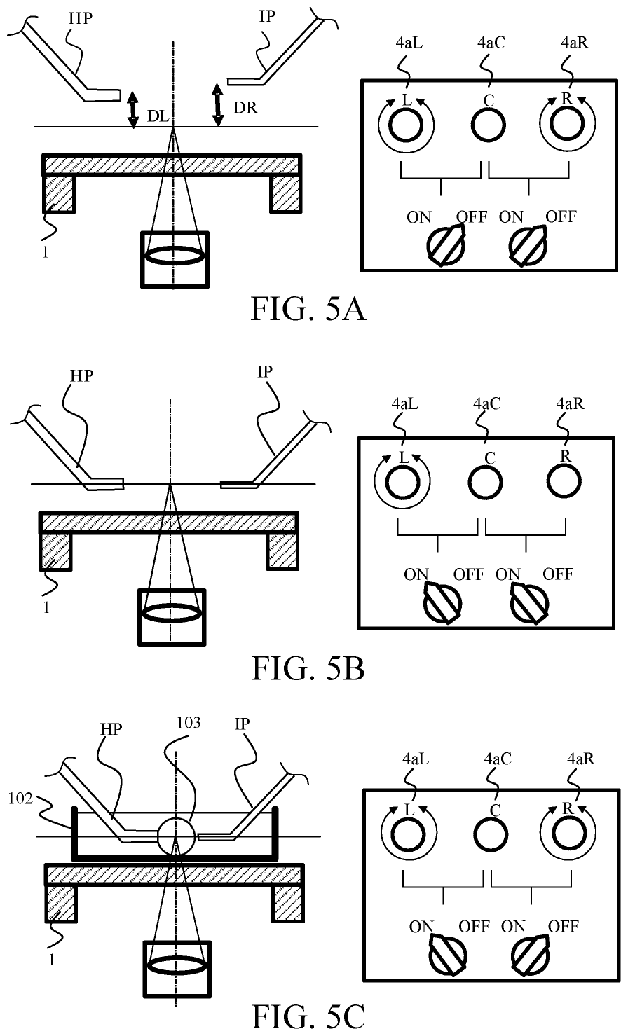

FIGS. 5A to 5C are explanatory diagrams of the effects in this embodiment. FIG. 5A is a diagram of a state immediately after the holding pipette HP and the injection pipette IP are attached. The positions of the holding pipette HP and the injection pipette IP in the optical axis direction are different, and thus the moving distances DL and DR to the focus position are different. Therefore, the linked mode is disabled, and the dials 4aL and 4aR are individually operated so that the holding pipette HP and the injection pipette IP individually move and their respective tips are aligned with the focus position. After that, the positions in the planar direction and tilts of the holding pipette HP and the injection pipette IP are properly adjusted.

FIG. 5B is a diagram illustrating a state after the tips of the holding pipette HP and the injection pipette IP are aligned with the focus position, and the positions in the plane direction, the tilts, and the like have been properly adjusted. Then, a petri dish, which is the observation tray 102, on which a cell, which is the object 103, is placed is set within a field of view of the microscope. The petri dish is set after the positions, tilts, etc. of the holding pipette HP and the injection pipette IP are adjusted because the cell has been stored in a culture chamber and the time the cell are kept out of the culture chamber is to be minimized. Here, in order that the petri dish is set, the holding pipette HP and the injection pipette IP are to be retracted. At this time, rather than moving the holding pipette HP and the injection pipette IP individually, enabling the linked mode and retracting them by a same distance at a same time can shorten the operation time. After the holding pipette HP and the injection pipette IP are retracted, the petri dish is to be set, and then the holding pipette HP and the injection pipette IP are to be returned to the focus position again. At this time as well, the operation time can be shortened by enabling the linked mode and simultaneously moving the holding pipette HP and the injection pipette IP by a same distance. This is because if both of them retract by the same distance and return by the same distance, the positions thereof are aligned with the focus position.

FIG. 5C is a diagram illustrating a state just before the injection pipette IP punctures the vicinity of the center of the cell held by the holding pipette HP. In a case where the position of the injection pipette IP in the optical axis direction is to be readjusted, only the injection pipette IP is to be moved and the positions of the others are to be maintained, so the linked mode is disabled and the dial 4aR is operated.

On the other hand, in a case where the position of the cell in the optical axis direction is to be readjusted, the linked mode is enabled for the operating unit movable portion 2L and the object movable portion 1. The operation time can be shortened by operating the dial 4aL or the dial 4aC and simultaneously moving the operating unit movable portion 2L and the object movable portion 1. Here, in a case where only the object movable portion 1 is moved with the linked mode disabled, the relative positions of the cells and the holding pipette HP are changed and the holding of the cells may become unstable.

In a case where a conventional microscope auxiliary apparatus not provided with the linked mode is used, the objective lens 104a is first adjusted so that the focus on the cell is readjusted. Thereafter, the position of the injection pipette IP is adjusted so that the focus on the injection pipette IP is readjusted, which takes time for the operation. On the other hand, in the case where the microscope auxiliary apparatus according to this embodiment is used, the linked mode is enabled so that movements of at least two movable portions of the object movable portion 1 and the operating unit movable portions 2L and 2R in the optical axis direction are linked. Thereby, the operation time can be shortened. The linked mode is not to be enabled all the time since there is a case where the linked mode is to be disabled, such as a case where the focus is to be adjusted immediately after the pipette is attached as illustrated in FIG. 5A. For this reason, a switch for enabling and disabling the linked mode is practically required.

In this embodiment, a description is given of a switch that mechanically reciprocates as an example of switching unit, but the switching unit may be a unit such as a touch switch and a foot pedal or may be, instead of a physical switch, a software switch that switches the mode in response to sounds or the like. This point is also similarly applied to each of the following embodiments.

In this embodiment, an example is described in which two sets of switches for enabling and disabling the linked mode are provided and the object movable portion 1 and the left and right operating unit movable portions 2L and 2R are objects to be moved. However, this embodiment is not limited to this, and a switch may be further provided with which movements are linked of the left and right operating unit movable portions 2L and 2R. Alternatively, one switch and a movable portion selecting unit (console 4) may be provided, and the movable portion selecting unit may be used for selecting portions to be simultaneously moved by the same moving amount in the linked mode from the object movable portion 1 and the operating unit movable portions 2L and 2R. As long as there are a plurality of objects to be moved, a similar configuration is possible even when the number of the objects to be moved is not three. In this embodiment, an example is described of an inverted microscope as the microscope 100, but a similar configuration is possible in a case where the microscope 100 is a real-image microscope with which an object is observed from an upper part or is a microscope of another type. These points are similarly applied to each of the following examples.

As described above, the microscope auxiliary apparatus attachable to the microscope 100 according to this embodiment includes the object movable portion 1, the first operating unit movable portion (operating unit movable portion 2L), and the second operating unit movable portion (operating unit movable portion 2R). The microscope auxiliary apparatus includes the movement instructing unit (dials 4aL, 4aC, and 4aR) and the switching unit (changeover switches 4bLC and 4bRC). The object movable portion moves the object 103 in the optical axis direction of the microscope. The first operating unit movable portion moves, in the optical axis direction, the first operating unit (operating unit 2La) for manipulating the object. The second operating unit movable portion moves, in the optical axis direction, the second operating unit (operating unit 2Ra) for manipulating the object. The movement instructing unit instructs the object movable portion, the first operating unit movable portion, or the second operating unit movable portion to move in the optical axis direction. The switching unit switches the mode to the first mode and to the second mode. The first mode is a mode (non-linked mode) that moves one of the object movable portion, the first operating unit movable portion, and the second operating unit movable portion in the optical axis direction according to the instruction from the movement instructing unit. The second mode is a mode (linked mode) that links movements of at least two of the object movable portion, the first operating unit movable portion, and the second operating unit movable portion in the optical axis direction and moves the at least two according to the instruction from the movement instructing unit. That is, the second mode is a mode that simultaneously moves at least two of the object movable portion, the first operating unit movable portion, and the second operating unit movable portion by a same moving amount in the optical axis direction according to the instruction from the movement instructing unit.

According to this embodiment, a microscope auxiliary apparatus can be provided that can shorten an operation time by linking movements of at least two movable portions including an object movable portion or an operating unit movable portion in an optical axis direction.

### Second Embodiment

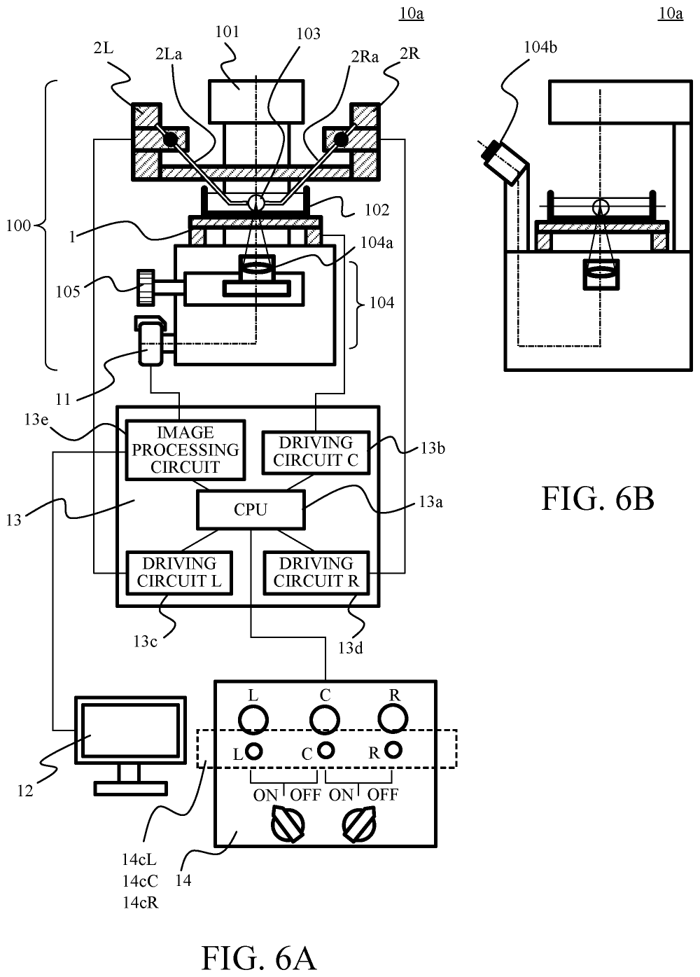

Next, a description is given of a microscope system according to a second embodiment of the present disclosure. FIGS. 6A and 6B are entire views of a microscope system 10a including a microscope (inverted microscope) 100 and a microscope auxiliary apparatus and illustrate a state in which the microscope auxiliary apparatus is attached to the microscope 100. The microscope auxiliary apparatus includes an object movable portion 1, an operating unit movable portions 2L and 2R, a display unit (display part) 12, a controller 13, and a console 14. FIG. 6A illustrates a front view of the microscope system 10a, and FIG. 6B illustrates a right view of the microscope system 10a. In FIGS. 6A and 6B, for clarity, some dimensions are exaggerated, some components are omitted, and some internal components are drawn with solid lines instead of dotted lines.

With reference to FIGS. 6A and 6B, a description is given of functions added in this embodiment to the functions described in the first embodiment. An unillustrated prism is added to the observation optical system, and an enlarged image can be formed on the image pickup unit 11. The image pickup unit 11 may be a dedicated device or may have a configuration such that a general digital camera is attached via a predetermined mount adapter. The image pickup unit 11 can acquire an image for performing autofocus of a “contrast method” or an “image pickup plane phase difference method” like a general digital camera.

A controller 13 includes an image processing circuit 13e that performs processing on an image acquired by the image pickup unit 11, in addition to a CPU 13a, a driving circuit C13b, a driving circuit L13c, and a driving circuit R13d. The image processing circuit 13e can perform various image processing on the image acquired by the image pickup unit 11 and output the processed image to an external display unit 12 as an image. Further, using the image acquired by the image pickup unit 11, the image processing circuit 13e can output, to the CPU 13a, image information for performing autofocus of the “contrast method” or the “image pickup plane phase difference method”.

Button switches 14cL, 14cC, and 14cR of the console 14 are inputting units capable of detecting that they are pressed and of triggering a predetermined process. In this embodiment, the button switches 14cL, 14cC, and 14cR are assigned a function of triggering an autofocusing process. When the button switch 14cC is pressed, the object movable portion 1 is moved in the optical axis direction and the autofocusing process is started. Moving the object movable portion 1 adjusts focus on the object 103 placed on the observation tray 102. As described above, conventional techniques of various methods can be used for automatically determining that the object is focused on. A method of recognizing an area in the vicinity of the object 103 may be a method of automatically determining the area by image recognition, or a method of manually specifying the area in advance by using the display unit 12.

Similarly, the button switches 14cL and 14cR are assigned functions of triggering autofocusing processes for the operating units 2La and 2Ra attached to the operating unit movable portions 2L and 2R. The autofocusing method and the method of recognizing the areas in the vicinity of the operating units 2La and 2Ra are similar to the methods used when the button switch 14cC is used.

In this embodiment, as in the first embodiment, dials 14aL, 14aC, and 14aR can be used when an instruction for manual focusing is given, and button switches 14cL, 14cC, and 14cR added in this embodiment can be used when an instruction for autofocusing is given. Thus, in this embodiment, the dials 4aL, 4aC, and 4aR and the button switches 14cL, 14cC, and 14cR function as a movement instructing unit that instructs the object movable portion 1 or the operating unit movable portion 2L or 2R to move in the optical axis direction of the microscope 100. The button switches 14cL, 14cC, and 14cR are an example of an automatic movement instructing unit that, when being pressed, starts a movement based on a predetermined input signal (with a predetermined input signal as a trigger) and automatically stops when a predetermined condition is satisfied. Alternatively, a touch panel can also be applied as an automatic movement instructing unit that automatically stops when a predetermined condition is satisfied.

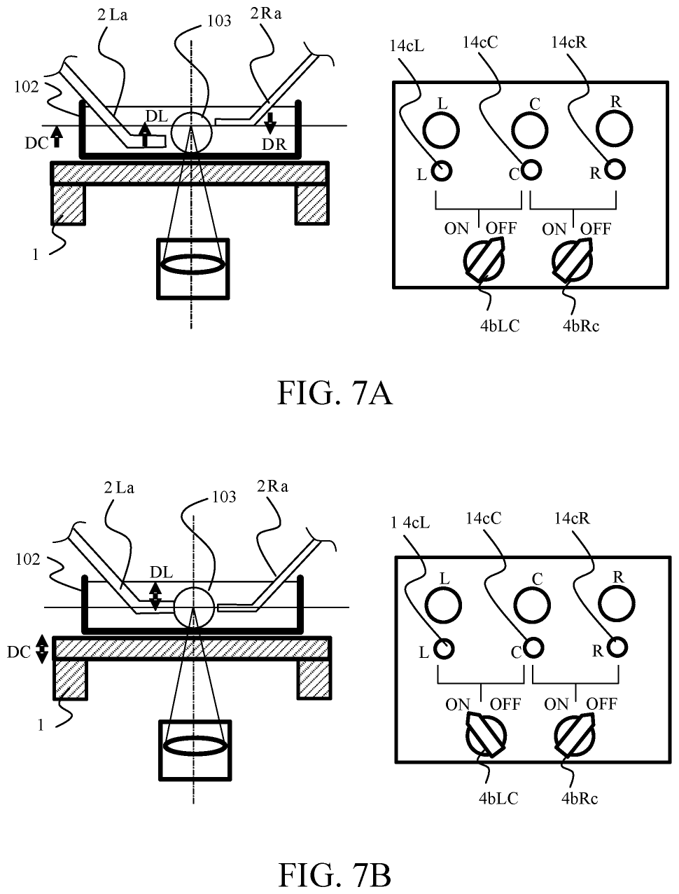

FIGS. 7A and 7B are explanatory diagrams of processes in this embodiment. First, with reference to FIG. 7A, a description is given of the non-linked mode during autofocusing. First, the changeover switches 4bLC and 4bRC are all switched to the linked mode OFF side. When the button switch 14cC is pressed, only the object movable portion 1 moves in the optical axis direction (DC direction in FIG. 7A). Thereby, it is possible to autofocus onto the object 103 placed on the observation tray 102. At this time, the focus on the operating units 2La and 2Ra attached to the operating unit movable portions 2L and 2R remains unchanged. Similarly, when the button switches 14cL and 14cR are pressed, only the operating units 2La and 2Ra attached to the operating unit movable portions 2L and 2R move in the optical axis direction (DL direction and DR direction in FIG. 7A), and it is possible to autofocus onto the operating units 2La and 2Ra. At this time, the focus on the object 103 remains unchanged.

Next, with reference to FIG. 7B, a description is given of the linked mode during autofocusing. A description is given of an example in which a movements of the left operating unit movable portion 2L and the object movable portion 1 are linked. First, the changeover switch 4bLC is switched to the linked mode ON side, and the changeover switch 4bRC is switched to the linked mode OFF side. As in a case where the linked mode is disabled, when the button switch 14cC is pressed, the object movable portion 1 moves in the optical axis direction so that the object 103 placed on the observation tray 102 is focused on. Here, in a state where the linked mode is enabled, the operating unit movable portion 2L for which the linked mode is selected also moves in the optical axis direction by the same moving amount at the same speed as the moving amount and the speed of the object movable portion 1. As a result, the focus on the operating unit 2La attached to the operating unit movable portion 2L changes as in the focus on the object 103. On the other hand, since the operating unit 2Ra attached to the operating unit movable portion 2R for which the linked mode is not selected does not move in the optical axis direction, the focus does not change.

Similarly, by switching the changeover switch 4bLC to the linked mode OFF side and the changeover switch 44bRC to the linked mode ON side, movements of the operating unit movable portion 2R and the object movable portion 1 can be linked. Also, by switching both the changeover switches 4bLC and 4bRC to the linked mode ON side, movements of three of the operating unit movable portions 2L and 2R and the object movable portion 1 can be linked.

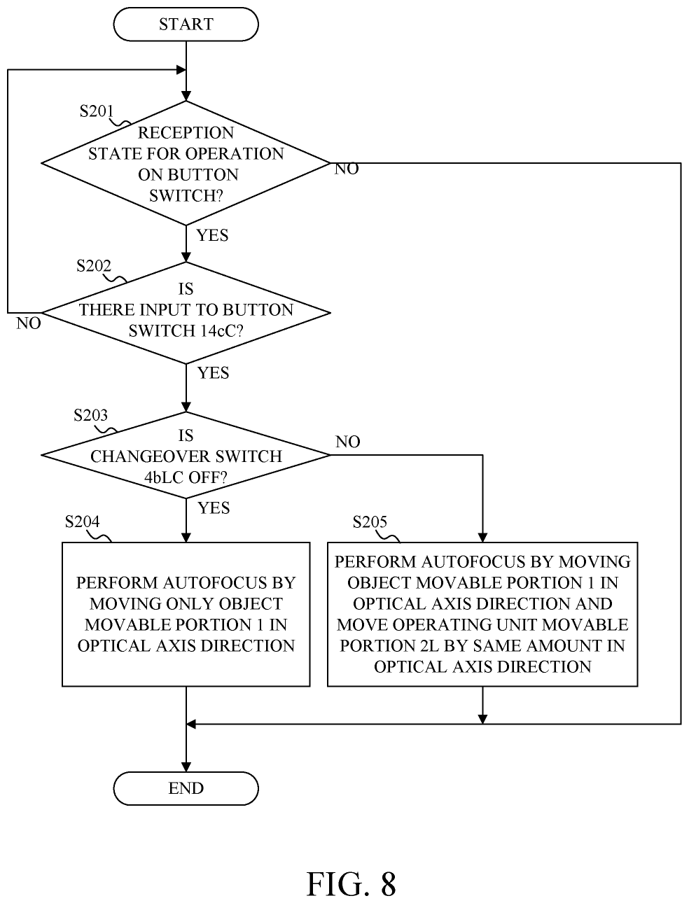

FIG. 8 is a flow chart illustrating the flow of a response to the button switch 14cC as an example of the processes illustrated in FIGS. 7A and 7B. First, in step S201, the controller 13 determines whether or not it is in a reception state for receiving an operation on the button switch 14cC. If it is in the reception state, the process proceeds to step S202. On the other hand, if it is not in the reception state, this flow ends.

In step S202, the controller 13 determines whether or not there is an input to the button switch 14cC. If there is an input, the process proceeds to step S203. On the other hand, if there is no input, the process returns to step S201.

In step S203, the controller 13 determines whether or not the changeover switch 4bLC is OFF. If the changeover switch 4bLC is OFF, the process proceeds to step S204. On the other hand, if the changeover switch 4bLC is ON, the process proceeds to step S205.

In step S204, since the changeover switch 4bLC is OFF, the microscope auxiliary apparatus acts in the non-linked mode. At this time, the controller 13 autofocuses onto the object by moving only the object movable portion 1 in the optical axis direction, and the process ends.

In step S205, since the changeover switch 4bLC is ON, the microscope auxiliary apparatus acts in the linked mode. At this time, the controller 13 autofocuses onto the object by moving only the object movable portion 1 in the optical axis direction and, at the same time, moves the operating unit movable portion 2L in the optical axis direction by the same amount as the moving amount of the object movable portion 1, and this flow ends.

A description is given of effects of the linked mode in cell manipulation as an example.

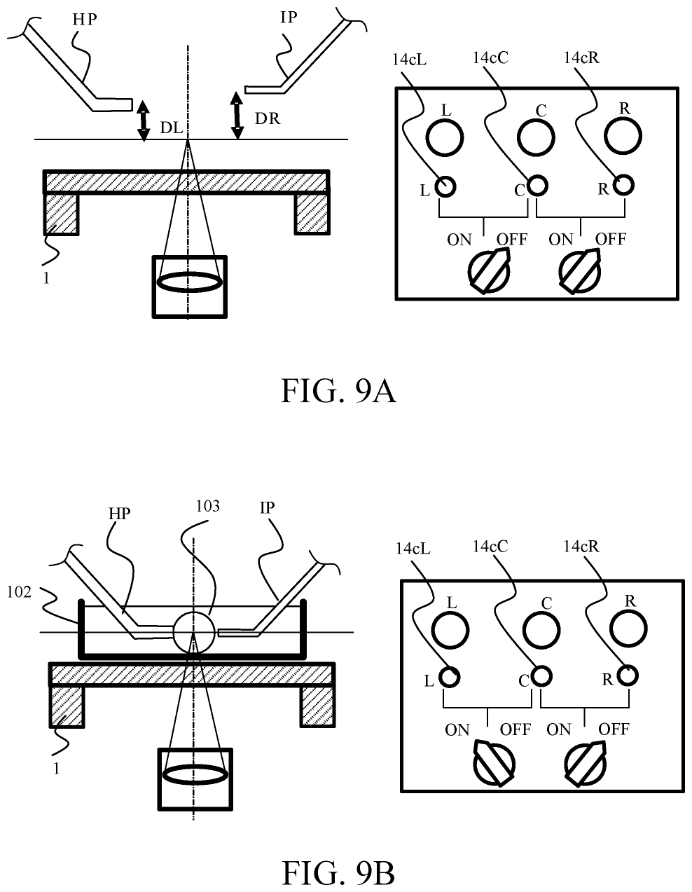

FIGS. 9A and 9B are explanatory diagrams of the effects in this embodiment. FIG. 9A is a diagram of a state immediately after the holding pipette HP and the injection pipette IP are attached. Since the positions of the holding pipette HP and the injection pipette IP in the optical axis direction are different, moving distances DL and DR to the focus position are different. Therefore, the linked mode is disabled, and the button switches 14cL and 14cR are individually pressed so that autofocusing is individually performed onto the holding pipette HP and the injection pipette IP. After that, the positions in the planar direction, tilts, etc. of the holding pipette HP and the injection pipette IP are appropriately adjusted.

FIG. 9B is a diagram illustrating a state just before the injection pipette IP punctures the vicinity of the center of the cell held by the holding pipette HP. In a case where the position of the injection pipette IP in the optical axis direction is to be readjusted, only the injection pipette IP is to be moved and the positions of the others are to be maintained, so the linked mode is disabled and the button switch 14cR is pressed.

On the other hand, in a case where the position of the cell in the optical axis direction is to be readjusted, the linked mode is enabled for the operating unit movable portion 2L and the object movable portion 1. The operation time can be shortened by operating the button switch 14cL or the button switch 14cC and simultaneously moving the operating unit movable portion 2L and the object movable portion 1. Here, in a case where only the object movable portion 1 is moved with the linked mode disabled, the relative positions of the cells and the holding pipette HP are changed and the holding of the cells may become unstable.

In a case where a conventional microscope auxiliary apparatus not provided with the linked mode is used, the objective lens 104a is first adjusted so that the focus on the cell is readjusted. Thereafter, the position of the injection pipette IP is adjusted so that the focus on the injection pipette IP is readjusted, which takes time for the operation. On the other hand, in the case where the microscope auxiliary apparatus according to this embodiment is used, the linked mode is enabled so that movements of at least two movable portions of the object movable portion 1 and the operating unit movable portions 2L and 2R in the optical axis direction are linked. Thereby, the operation time can be shortened. The linked mode is not to be enabled all the time since there is a case where the linked mode is to be disabled, such as a case where the focus is to be adjusted immediately after the pipette is attached as illustrated in FIG. 9A. For this reason, a switch for enabling and disabling the linked mode is practically required.

According to this embodiment, a microscope auxiliary apparatus can be provided that can shorten an operation time by linking movements of at least two movable portions including an object movable portion or an operating unit movable portion in an optical axis direction.

### Third Embodiment

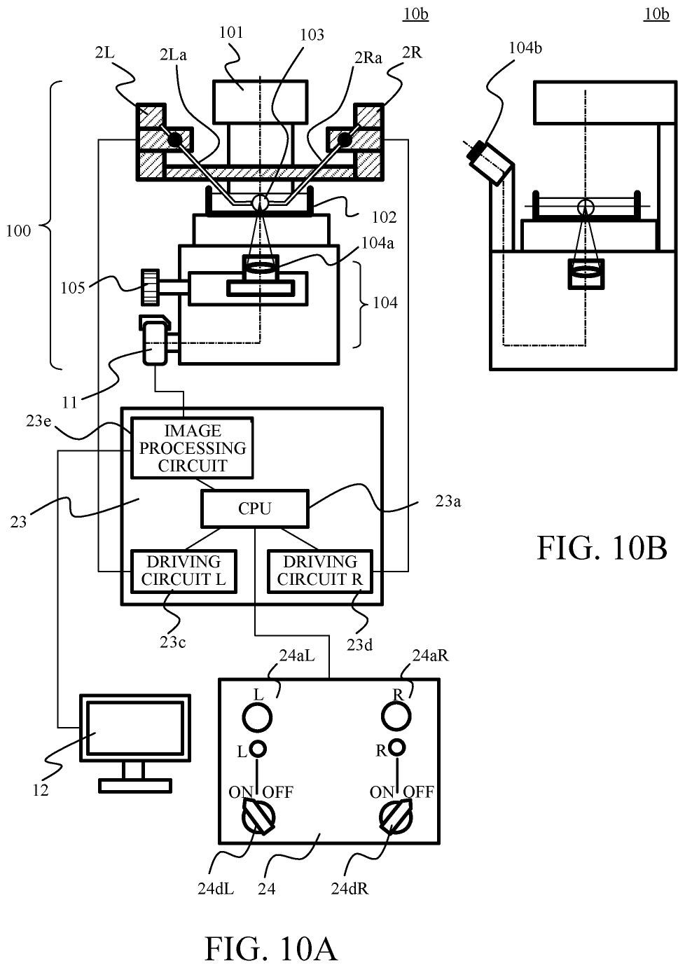

Next, a description is given of a microscope system according to a third embodiment of the present disclosure. FIGS. 10A and 10B are entire views of a microscope system 10b including a microscope (inverted microscope) 100 and a microscope auxiliary apparatus and illustrate a state in which the microscope auxiliary apparatus is attached to the microscope 100. The microscope auxiliary apparatus includes operating unit movable portions 2L and 2R, a display unit (display part) 12, a controller 23, and a console 24. FIG. 10A illustrates a front view of the microscope system 10b, and FIG. 10B illustrates a right view of the microscope system 10b. In FIGS. 10A and 10B, for clarity, some dimensions are exaggerated, some components are omitted, and some internal components are drawn with solid lines instead of dotted lines.

With reference to FIGS. 10A and 10B, a description is given of functions removed or added in this embodiment from or to the functions described in the second embodiment. In this embodiment, the object movable portion 1 and the driving circuit C in the second embodiment are not provided. Therefore, in this embodiment, focus on an object is adjusted by rotating the knob 105 of the microscope and moving the objective lens 104a in the optical axis direction. The controller 23 includes a CPU 23a, a driving circuit L23c, a driving circuit R23d, and an image processing circuit 23e.

Changeover switches 24dL and 24dR can be operated left and right so that the operation mode is switched. The changeover switches 24dL and 24dR are changeover switches capable of reciprocating in two directions including “ON” for enabling a “linked mode” described below and “OFF” for disabling the “linked mode”.

In a case where the linked mode is disabled, a non-linked mode, which is conventional, is enabled in which even when the knob 105 is operated and the objective lens 104a is moved in the optical axis direction, the operating unit movable portions 2L and 2R do not move in the optical axis direction. On the other hand, in a case where the “linked mode” is enabled, when the knob 105 is operated and the objective lens 104a moves in the optical axis direction, the operating unit movable portions 2L and 2R are simultaneously moved by the same moving amount as the moving amount of the objective lens 104a. Thus, the changeover switches 24dL and 24dR function as a switching unit that switches the mode to the linked mode (second mode) and to a non-linked mode (first mode).

A description is given of a method of simultaneously moving the operating unit movable portions 2L and 2R by the same moving amount as the objective lens 104a when the objective lens 104a is moved in the optical axis direction in the linked mode. When the objective lens 104a is moved, the focus position moves in the optical axis direction, and thus the focus on the operating units 2La and 2Ra attached to the operating unit movable portions 2L and 2R changes. A change in the focus can be detected as temporal changes acquired as a result of calculation of a predetermined in-focus evaluation value in the image pickup unit 11. The predetermined in-focus evaluation value is acquired by calculating a contrast of the acquired image in a case of the contrast method, and by comparing two images from which a phase difference can be detected by pupil division in a predetermined direction in a case of the image pickup plane phase difference method. These are conventional techniques commonly used in digital cameras. Then, by performing feedback control such that the in-focus evaluation value is maintained of the observation image of the microscope 100 acquired by the image pickup unit 11, the position of the objective lens 104a in the optical axis direction can be maintained relatively to the focus position. As a result, movements of the operating unit movable portions 2L and 2R in the optical axis direction can be linked and they are moved by the same distance as the moving distance of the objective lens 104a of the microscope 100 in the optical axis direction.

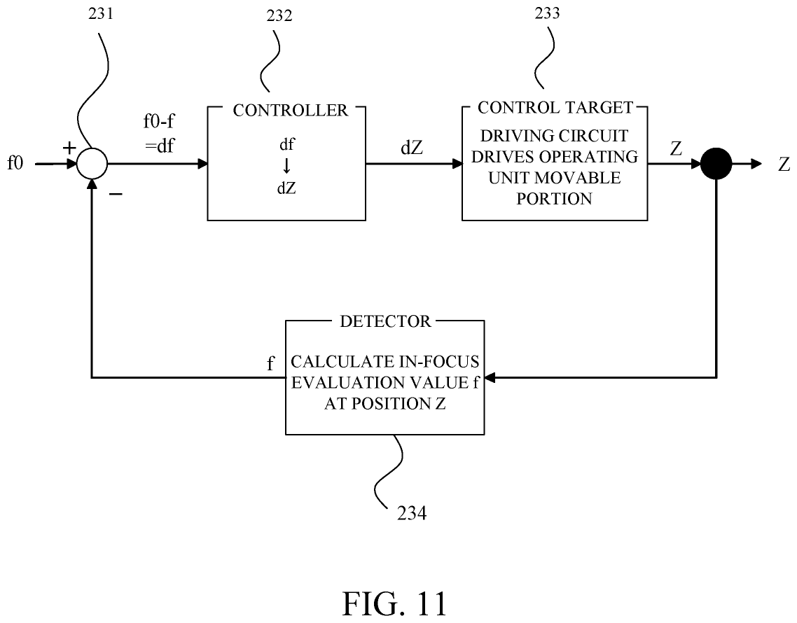

FIG. 11 is a block diagram of the feedback control performed in the linked mode. The controller 23 stores in advance an initial value f0 of an in-focus evaluation value f as a target value. The CPU 23a (comparing unit 231) calculates a difference df between the target value f0 and a current in-focus evaluation value f. The CPU 23a (controlling unit) 232 performs calculation such that the difference f0−f=df is converted from the difference in the in-focus evaluation values to a shift amount in the optical axis direction, and sets the calculated value to a target value dZ of a relative moving amount of the operating unit movable portion, which is an object to be controlled. The controller 23 (driving circuit 233) drives the operating unit movable portion so as to relatively move it by dZ, and a current position Z of the operating unit movable portion is output. The controller 23 (detector 234) also calculates the in-focus evaluation value f at the current position Z and performs feedback control. In this manner, the feedback control is performed such that the in-focus evaluation value of the observation image of the microscope 100 acquired by the image pickup unit 11 is maintained at a constant value. As a result, the movement of the operating unit movable portion in the optical axis direction can be linked to the movement of the objective lens 104a of the microscope so that the operating unit movable portion is moved by the same distance as the moving distance in the optical axis direction of the objective lens 104a.

The feedback control in this embodiment maintains the in-focus evaluation value, and does not raise the in-focus evaluation value to bring it closer to in focus. This is because the purpose of the linked mode is not to bring the state into an in-focus state, but to move the operating unit movable portions 2L and 2R by the same amount as the moving amount of the objective lens 104a in the optical axis direction.

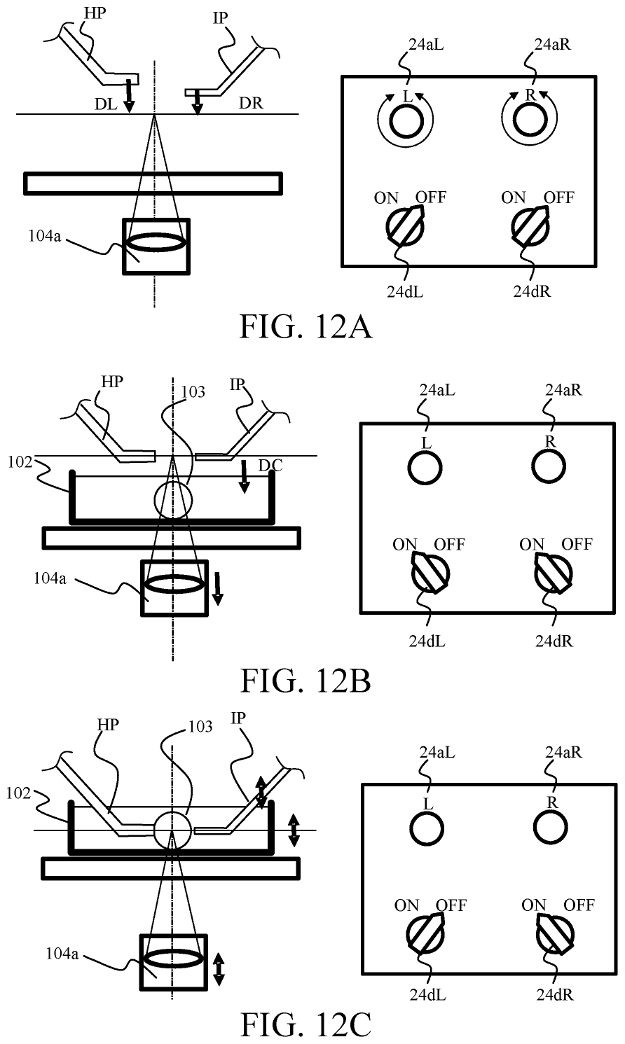

A description is given of effects of the linked mode in cell manipulation as an example. FIGS. 12A to 12C are explanatory diagrams of the effects in this embodiment. FIG. 12A is a diagram of a state immediately after the holding pipette HP and the injection pipette IP are attached. The positions of the holding pipette HP and the injection pipette IP in the optical axis direction are different, and thus the moving distances DL and DR to the focus position are different. Therefore, the linked mode is disabled, and the dials 24aL and 24aR are individually operated so that the holding pipette HP and the injection pipette IP individually move and their respective tips are aligned with the focus position. After that, the positions in the planar direction, tilts, etc. of the holding pipette HP and the injection pipette IP are properly adjusted.

FIG. 12B is a diagram illustrating a state in which a petri dish, which is the observation tray 102, on which a cell, which is the object 103, is placed is set within a field of view of the microscope after the tips of the holding pipette HP and the injection pipette IP are aligned with the focus position and adjustment is properly performed. The petri dish is set after the positions, tilts, etc. of the holding pipette HP and the injection pipette IP are adjusted because the cell has been stored under a proper environment in a culture chamber and the time the cell is kept out of the culture chamber is to be minimized. After that, the set object 103 is to be focused on. Here, the changeover switches 24dL and 24dR are switched so that the linked mode is enabled, the objective lens is adjusted, and the focus position is moved in the direction of the arrow DC. When the focus plane moves to the center of object 103, since the linked mode is enabled, the holding pipette HP and the injection pipette IP are also moved similarly to the objective lens 104a, and thus the holding pipette HP and the injection pipette IP can be moved by operating only the objective lens 104a. Conventionally, movements of the objective lens 104a, the holding pipette HP, and the injection pipette IP are not linked, and therefore three operations are performed. On the other hand, according to this embodiment, the operation time can be shortened because the operation is completed with a single operation.

FIG. 12C is a diagram illustrating a state just before the injection pipette IP punctures the vicinity of the center of the cell held by the holding pipette HP. In this state, in a case where the position of the cell in the optical axis direction is to be readjusted, the relative positions of the holding pipette HP and the cell are to be maintained, and therefore the changeover switch 24dL is switched to the linked mode OFF side. On the other hand, the focus on the injection pipette IP is to be maintained, the changeover switch 24dR is switched to the linked mode ON side. Adjusting the position of the objective lens 104a in this state can adjust the focus on the cell while maintaining the relative positions of the cell and the holding pipette HP holding the cell, and the movement of the injection pipette IP whose focus is to be maintained is linked to the movement of the objective lens 104a. As a result, the focus can be finely adjusted with a single operation, which shortens the operation time. At this time, the linked mode is not to be enabled all the time since there is a case where the linked mode is to be disabled, so a switch for enabling and disabling the linked mode is practically required.

In this embodiment, even in a case where the linked mode is selected, if the in-focus evaluation value of the observation image is equal to or smaller than a predetermined value, since there is no point in linking the movements, the movement of the operating unit movable portion in the optical axis direction may not be linked to the movement of the objective lens.

### Fourth Embodiment

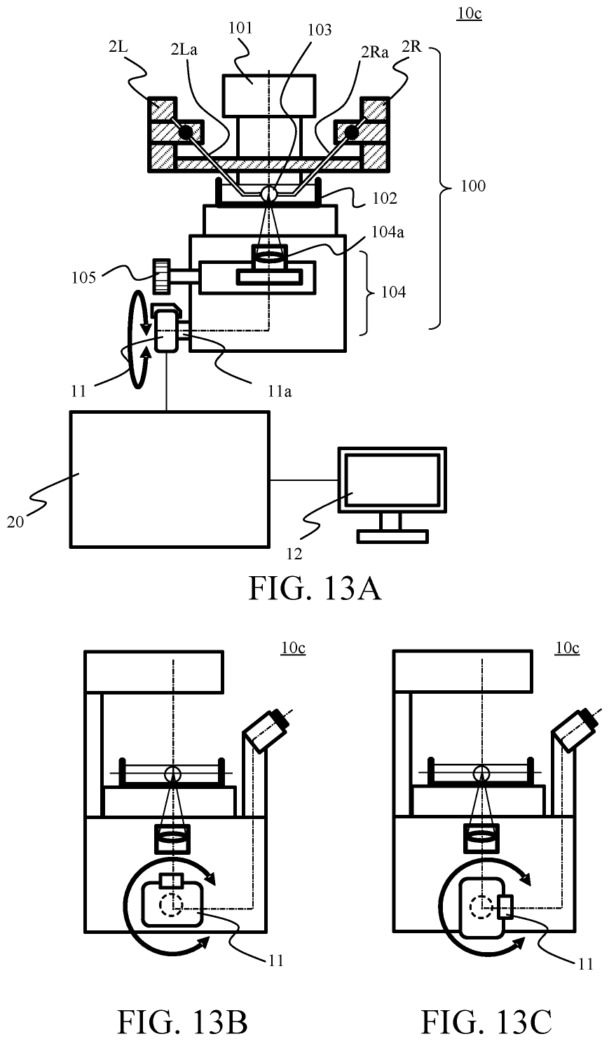

Next, a description is given of a microscope system according to a fourth embodiment of the present disclosure. FIGS. 13A to 13C are entire views of a microscope system 10c including a microscope (inverted microscope) 100 and a microscope auxiliary apparatus and illustrate a state in which the microscope auxiliary apparatus is attached to the microscope 100. The microscope auxiliary apparatus includes operating unit movable portions 2L and 2R, a display unit 12, and an image processing unit 20. FIG. 13A illustrates a front view of the microscope system 10c, and FIGS. 13B and 13C illustrate a left view of the microscope system 10c. In FIGS. 13A to 13C, for clarity, some dimensions are exaggerated, some components are omitted, and some internal components are drawn with solid lines instead of dotted lines.

With reference to FIGS. 13A to 13C, a description is given of functions added in this embodiment to the functions described in the third embodiment. An image pickup unit (image pickup apparatus) 11 in this embodiment is capable of acquiring two images from which a phase difference can be detected by pupil division in a predetermined direction, and includes an image pickup sensor capable of acquiring an observation image (captured image) of the microscope 100. The image pickup unit 11 is capable of so-called image pickup plane phase difference AF. The image pickup unit 11 is attached to the microscope 100 via a mount 11a. The mount 11a in this embodiment is rotatable about the optical axis of the image pickup unit 11 as indicated by arrows in FIGS. 13A to 13C. Therefore, the mount 11a functions as an image pickup unit rotating unit capable of rotating the image pickup unit 11 relatively to the microscope 100.

An image processing apparatus (image processing unit) 20 includes an image rotating unit 201 that generates a rotated image acquired by rotating, by a predetermined angle, an image that has been acquired by the image pickup unit 11, and an image outputting unit 202 capable of outputting the rotated image rotated by the predetermined angle to an external display unit 12. With these configurations, even in a case where the image pickup unit 11 is rotated by a predetermined angle by the mount 11a, which is the image pickup unit rotating unit, and the observation image is acquired in a state of being rotated by the predetermined angle, the image rotating unit 201 can generate an image that is reversely rotated by the predetermined angle. As a result, the image outputting unit can output, to the display unit 12, an image captured in a state where the image pickup unit 11 is not rotated by the predetermined angle.

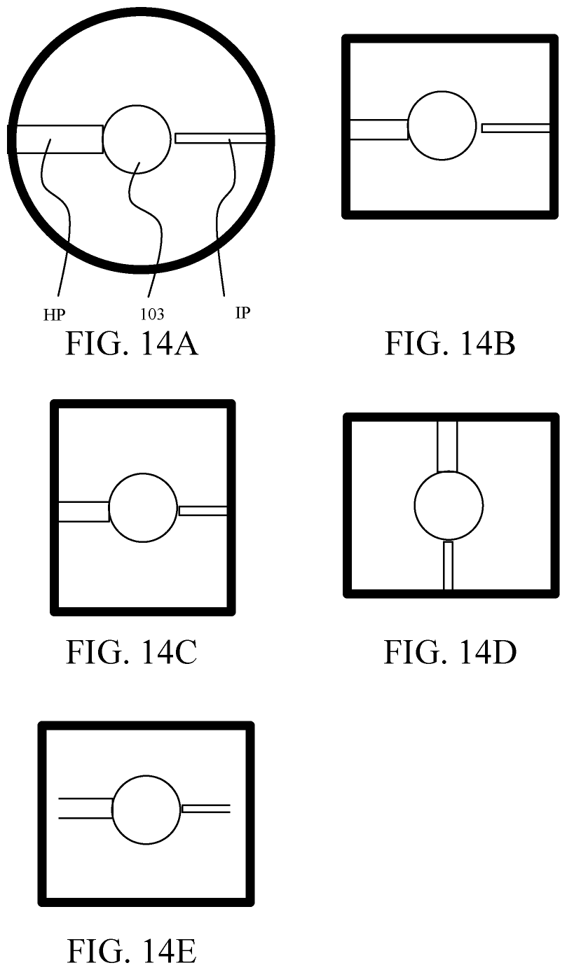

Next, with reference to FIGS. 14A to 14E, a description is given of effects of this embodiment in a case where the holding pipette HP and the injection pipette IP are inserted from the left and right directions as an example. FIGS. 14A to 14E are explanatory diagrams of the effects in this embodiment.

FIG. 14A is an optical image observed through an eyepiece lens 104b when a cell is manipulated, and, normally, a part of the optical image is cut out as it is and output to the display unit 12 as illustrated in FIG. 14B. This is because an observed view may be output and recorded as it is.

Here, a pupil division direction of the image pickup plane phase difference AF is normally a horizontal direction of FIG. 14B. On the other hand, in cell manipulation work, the holding pipette HP or the injection pipette IP is normally inserted into the field of view from the left and right. For this reason, as illustrated in FIG. 14B, an image is acquired that includes few straight lines in a vertical direction (direction orthogonal to the pupil division direction), and parallax in the image pickup plane phase difference AF is small, which may reduce AF accuracy. Therefore, the image pickup unit 11 is attached while being rotated by a predetermined angle (90 degrees in this embodiment) so that an image is acquired as illustrated in FIG. 14C. As a result, the parallax in the image pickup plane phase difference AF is increased, which can improve the AF accuracy.

However, in a case where the image is output and recorded as it is, an image rotated by 90 degrees relatively to the optical image is output and recorded, as illustrated in FIG. 14D. As a result, it becomes uncomfortable to view the image on the display unit 12 or to reproduce the recorded image later. Therefore, the image rotating unit 201 generate an image reversely rotated by 90 degrees and outputs and records the image as illustrated in FIG. 14E, which causes missing in the image at a peripheral part but can avoid the discomfort when the image is viewed on the display unit 12 or the recorded image is reproduced later.

According to this embodiment, it is possible to improve the AF accuracy of the image pickup plane phase difference AF. As a result, the accuracy can be improved of the linked movement of at least two movable portions including the object movable portion or the operating unit movable portion in the optical axis direction, and the operation time can be shortened.

### Fifth Embodiment

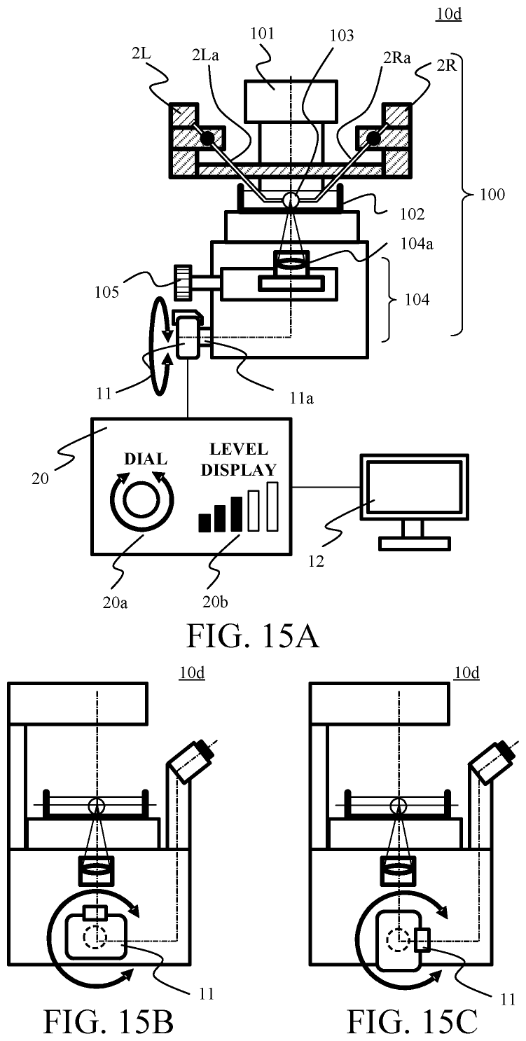

Next, a description is given of a microscope system according to a fifth embodiment of the present disclosure. FIGS. 15A to 15C are entire views of a microscope system 10d including a microscope (inverted microscope) 100 and a microscope auxiliary apparatus and illustrate a state in which the microscope auxiliary apparatus is attached to the microscope 100. The microscope auxiliary apparatus includes operating unit movable portions 2L and 2R, a display unit 12, and an image processing unit 20. FIG. 15A illustrates a front view of the microscope system 10, and FIGS. 15B and 15C illustrate left views of the microscope system 10. In FIGS. 15A and 15C, for clarity, some dimensions are exaggerated, some components are omitted, and some internal components are drawn with solid lines instead of dotted lines.

With reference to FIGS. 15A to 15C, a description is given of functions added in this embodiment to the functions described in the fourth embodiment. An image processing apparatus (image processing unit) 20 in this embodiment includes a dial 20a and a level display 20b in addition to an image rotating unit 201 and an image outputting unit 202. The dial 20a is a rotational angle changing unit that changes an angle by which the image rotating unit 201 rotates an image. The level display 20b is a display unit that displays a shift change between two parallax images acquired by the image pickup unit 11. In the level display 20b, the larger an illuminated LED frame on a right side, the greater the parallax between the two images, and thus it is indicated that the image is captured with good AF accuracy of the image pickup plane phase difference AF.

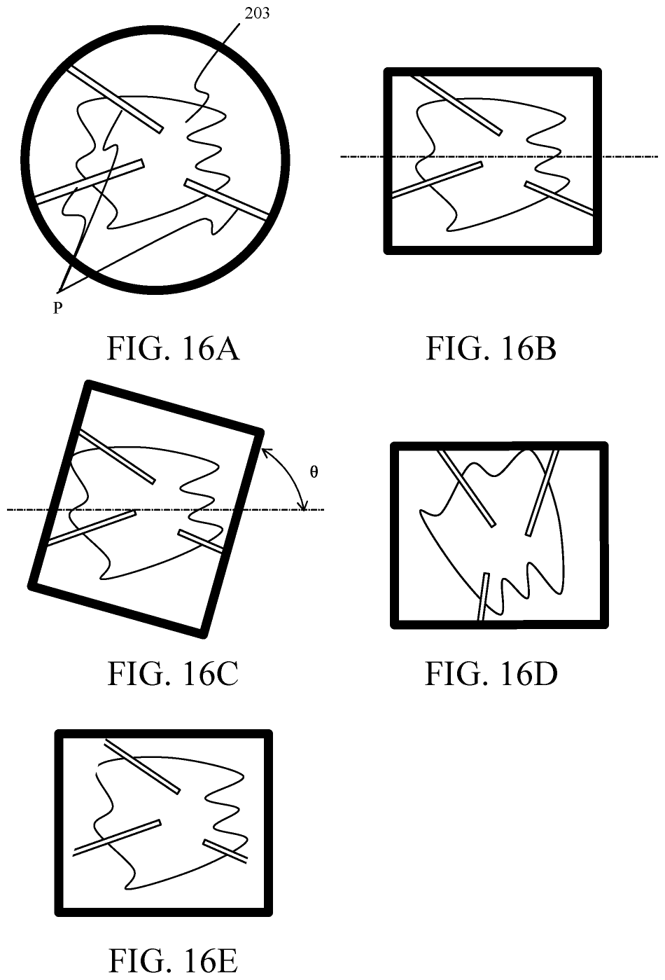

Next, with reference to FIGS. 16A to 16E, a description is given of effects of this embodiment, and an example is described of a case where probes are brought into contact with cell tissue from various directions. FIGS. 16A to 16E are explanatory diagrams of the effects of this embodiment. FIG. 16A is an optical image observed through the eyepiece lens 104b when three probes P are brought into contact with cell tissue 203. Normally, as illustrated in FIG. 16B, part of the optical image is cut out as it is and output to the display unit 12. This is because an observed optical image may be output and record as it is.

A pupil division direction of the image pickup plane phase difference AF is normally a horizontal direction of FIG. 16B. In this work, the probes are brought into contact with the cell tissue 203 from various directions. For this reason, as illustrated in FIG. 16B, the image includes few straight lines crossing at 45 degrees or less in a vertical direction (the direction orthogonal to the pupil division direction), and the parallax in the image pickup plane phase difference AF is small, which may lower the AF accuracy. Therefore, the image pickup unit 11 is attached while being rotated by an angle θ, and an image such as that illustrated in FIG. 16C is acquired so that the parallax in the image pickup plane phase difference AF becomes large, which can improve the AF accuracy.

However, in a case where the image is output and recorded as it is, an image rotated by the angle θ from the optical image is output and recorded, as illustrated in FIG. 16D. As a result, it becomes uncomfortable to view the image on the display unit 12 or to reproduce the recorded image later. Therefore, the image rotating unit 201 generate an image reversely rotated by the angle θ and outputs and records the image as illustrated in FIG. 16E, which causes missing in the image at a peripheral part but can avoid the discomfort when the image is viewed on the display unit 12 or the recorded image is reproduced later. The angle θ by which the image pickup unit 11 is rotated can be set to an angle at which the level display 20b indicates the maximum level while the display on the level display 20b is referred to. By using the dial 20a, the angle by which an image is reversely rotated when the image rotating unit 201 generates an image can be adjusted to an angle such that the angles of the optical image in FIG. 16A and the output image in FIG. 16E are equivalent to each other.

In this embodiment, an example is described in which an image is manually rotated via the dial 20a, but the rotation angle θ of the image pickup unit 11 may be detected by a sensor or the like on the mount 11a and the image rotating unit may automatically determine the angle by which the image is reversely rotated when generating an image.

According to this embodiment, it is possible to improve AF accuracy of image pickup plane phase difference AF. As a result, accuracy can be improved of linked movements of at least two movable portions including the object movable portion or the operating unit movable portion in the optical axis direction, and the operation time can be shortened.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A microscope auxiliary apparatus attachable to a microscope, the microscope auxiliary apparatus comprising:
an object movable portion configured to move an object in an optical axis direction of the microscope;
a first operating unit movable portion configured to move, in the optical axis direction, a first operating unit for operating the object;
a second operating unit movable portion configured to move, in the optical axis direction, a second operating unit for operating the object;
a movement instructing unit configured to instruct the object movable portion, the first operating unit movable portion, or the second operating unit movable portion to move in the optical axis direction; and
a switching unit configured to switch a mode to a first mode and a second mode,
wherein the first mode is a mode that moves one of the object movable portion, the first operating unit movable portion, and the second operating unit movable portion in the optical axis direction according to an instruction from the movement instructing unit, and
wherein the second mode is a mode that links movements of at least two of the object movable portion, the first operating unit movable portion, and the second operating unit movable portion and moves the at least two in the optical axis direction according to the instruction from the movement instructing unit.

2. The microscope auxiliary apparatus according to claim 1, wherein the second mode is a mode that simultaneously moves at least two of the object movable portion, the first operating unit movable portion, and the second operating unit movable portion in the optical axis direction by same moving amounts according to the instruction from the movement instructing unit.

3. The microscope auxiliary apparatus according to claim 1, wherein the movement instructing unit is a manual movement instructing unit via which a moving amount and a moving direction are input.

4. The microscope auxiliary apparatus according to claim 1, wherein the movement instructing unit is an automatic movement instructing unit configured to:
instruct the object movable portion, the first operating unit movable portion, or the second operating unit movable portion to start to move based on a predetermined input signal; and
instruct the object movable portion, the first operating unit movable portion, or the second operating unit movable portion to stop moving when a predetermined condition is satisfied.

5. The microscope auxiliary apparatus according to claim 1, further comprising a movable portion selecting unit configured to select at least two of the object movable portion, the first operating unit movable portion, and the second operating unit movable portion of which movements are to be linked in the second mode.

6. A microscope auxiliary apparatus attachable to a microscope, the microscope auxiliary apparatus comprising:
an operating unit movable portion configured to move, in an optical axis direction of the microscope, an operating unit for operating an object; and
an image pickup unit configured to acquire an observation image of the microscope,
wherein based on the observation image, the operating unit movable portion moves in the optical axis direction by a same distance as a moving distance of an objective lens of the microscope in the optical axis direction while a movement of the operating unit movable portion is linked to a movement of the objective lens.

7. The microscope auxiliary apparatus according to claim 6, wherein by performing feedback control such that an in-focus evaluation value of the observation image is maintained at a constant value, the operating unit movable portion moves in the optical axis direction while the movement of the operating unit movable portion is linked to the movement of the objective lens.

8. The microscope auxiliary apparatus according to claim 6, further comprising a switching unit configured to switch a mode to a first mode and to a second mode,
wherein in the first mode, when the objective lens moves in the optical axis direction, the operating unit movable portion does not move in a manner that the movement of the operating unit movable portion is linked to the movement of the objective lens, and
wherein in the second mode, based on the observation image, the operating unit movable portion moves in the optical axis direction by the same distance as the moving distance of the objective lens in the optical axis direction while the movement of the operating unit movable portion is linked to the movement of the objective lens.

9. The microscope auxiliary apparatus according to claim 8, wherein in a case where the switching unit has selected the second mode and the in-focus evaluation value of the observation image is equal to or smaller than a predetermined value, the operating unit movable portion does not move in a manner that the movement of the operating unit movable portion is linked to the movement of the objective lens.

10. A microscope auxiliary apparatus attachable to a microscope, the microscope auxiliary apparatus comprising:
an operating unit movable portion configured to move, at least in an optical axis direction of the microscope, an operating unit for operating an object;
an image pickup unit configured to acquire two images by pupil division in a predetermined direction so that a phase difference is detected;
an image pickup unit rotating unit configured to rotate the image pickup unit relatively to the microscope; and
an image rotating unit configured to generate a rotated image by rotating, by a predetermined angle, an image acquired by the image pickup unit.

11. The microscope auxiliary apparatus according to claim 10, further comprising an image outputting unit configured to output the rotated image to a display part.

12. The microscope auxiliary apparatus according to claim 10, wherein the predetermined angle is 90 degrees.

13. The microscope auxiliary apparatus according to claim 10, further comprising a rotational angle changing unit configured to change the predetermined angle.

14. The microscope auxiliary apparatus according to claim 10, further comprising a display unit configured to display a change in a shift between the two images.
